(19) United States
(12) Patent Application Publication
(10) Pub. No.: US 2025/0278918 A1
(43) Pub. Date: Sep. 4, 2025

(54) SYSTEM AND METHOD FOR GENERATING MEDIA PRESENTATION WITH ZOOM-IN EFFECT

(71) Applicant: Samsung Electronics Co., Ltd., Suwon-si (KR)

(72) Inventors: Ruchika SAXENA, Noida (IN); Maneesh JAIN, Noida (IN); Ramakant SINGH, Noida (IN); Ashok JAIN, Noida (IN)

(21) Appl. No.: 19/213,505

(22) Filed: May 20, 2025

Related U.S. Application Data
(63) Continuation of application No. PCT/KR2023/016314, filed on Oct. 20, 2023.

(30) Foreign Application Priority Data
Dec. 13, 2022 (IN) 202211072049

(51) Int. Cl. G06V 10/25; G06T 3/40; G06T 7/11; G06T 7/50; G06T 7/70; G06V 10/44; G06V 10/74; G06V 10/762

(52) U.S. Cl. CPC G06V 10/25; G06T 3/40; G06T 7/11; G06T 7/50; G06T 7/70; G06V 10/44; G06V 10/761; G06V 10/762; G06T 2207/20084

(57) ABSTRACT

A method and system for generating a media presentation. The method includes receiving a first image, from a media objects comprising a specified object. The method includes identifying a region of interest (ROIs) in the first image based on the specified object. Further, the method includes determining a zoomable ROI from the identified ROIs, with a zoom-in effect. The method includes retrieving a consecutive image from the media objects based on the zoomable ROI. Further, the method includes generating the consecutive image based on the zoomable ROI based on a failure to retrieve the consecutive image from the media objects and embedding the consecutive image with the first image to generate the media presentation.

### CROSS-REFERENCE TO RELATED APPLICATIONS

This application is a continuation of International Application No. PCT/KR2023/016314 designating the United States, filed on Oct. 20, 2023, in the Korean Intellectual Property Receiving Office and claiming priority to Indian Patent Application No. 2022211072049, filed on Dec. 13, 2022, in the Indian Patent Office, the disclosures of each of which are incorporated by reference herein in their entireties.

### BACKGROUND

The disclosure relates to stitching together media presentation and for example relates to system and method generating media presentation in relevant sequence with zoom-in effect.

### DESCRIPTION OF RELATED ART

With the progress in content development, creators are in requirement of developing engaging content while reducing efforts to do the same. It may be required that engaging content offers something new to a viewer such as a new perspective, an unexpected laugh, some knowledge, or something helpful, inspiring, or entertaining. Engaging content may provide the viewer a peek at something they haven't seen before but can relate to in some way.

The existing techniques require the creator to put in manual efforts for editing the content to create new experiences, such as transitioning content. Such manual efforts may be time and resource consuming. In an example to create engaging content with media files such as images, the user may create visual transitions. In visual transition, animation may introduce a new visual component to the scene or existing content by replacing a component or media file already in the scene. Further, the user may require a special effect such as zooming into a current media file which may be currently visible to the viewer or any component in the current media file before transitioning to a consecutive media file.

In existing technologies, the creator may have to manually scheme through multiple media files to arrange them in sequential order to create a zoomable effect transition between multiple media files. The zoomable effect transition between media files may create a zooming in-effect for the viewer, wherein the component in the current media file is zoomed-in and subsequently the consecutive media file appears. It may be required that the consecutive media file is contextually relevant to the current media file such that the viewer may experience zooming-in on the component and the consecutive media file out of the zoomed-in component.

Creating such zooming-in transitioning effect in the media presentation may require considerable time and manual efforts by the creator. The creator may have to manually arrange the media files in sequential order so that contextual relevance is maintained. Moreover, the creator may need to identify a region of interest in each of the media file which may be zoomed-in to present the consecutive media file. In an event the creator does not have contextually relevant image, the zooming-in transition effect may not provide relevant experience and may seem inappropriate.

### SUMMARY

According to an example embodiment of the present disclosure, a method for generating a media presentation is disclosed. The method includes: receiving a first image, from a plurality of media objects comprising a plurality of specified objects; identifying a plurality of regions of interest (ROIs) in the first image based on the specified objects; determining at least one zoomable ROI from the identified plurality of ROIs, wherein the at least one zoomable ROI includes one of the plurality of ROIs with a zoom-in effect; retrieving a consecutive image from the plurality of media objects based on the at least one zoomable ROI; and generating the consecutive image based on the at least one zoomable ROI based on failure to retrieve the consecutive image from the plurality of media objects and embedding the consecutive image with the first image to generate the media presentation.

According to an example embodiment of the present disclosure, a system for generating a media presentation is disclosed. The system includes: an identification module comprising circuitry configured to receive a first image, from a plurality of media objects comprising a plurality of specified objects and identify a plurality of regions of interest (ROIs) in the first image based on the specified objects; a determining module comprising circuitry configured to determine at least one zoomable ROI from the identified plurality of ROIs, wherein the at least one zoomable ROI includes one of the plurality of ROIs with a zoom-in effect; a retrieving module comprising circuitry configured to retrieve a consecutive image from the plurality of media objects based on the at least one zoomable ROI; and a generating module comprising circuitry configured to generate the consecutive image based on the at least one zoomable ROI based on failure to retrieve the consecutive image from the plurality of media objects and embed the consecutive image with the first image for generating the media presentation.

To further clarify the advantages and features of the disclosure, a more detailed description will be provided with reference to various example embodiments thereof, which are illustrated in the appended drawings. It is appreciated that these drawings depict example embodiments and are therefore not to be considered limiting of its scope. The disclosure will be described and explained with additional specificity and detail with the accompanying drawings.

### BRIEF DESCRIPTION OF THE DRAWINGS

The above and other features, aspects, and advantages of certain embodiments of the present disclosure will be more apparent from the following detailed description, taken in conjunction with the accompanying drawings in which like characters represent like parts throughout the drawings, and in which:

FIG. 1 is a diagram illustrating an environment for the implementation of a system for generating a media presentation, according to various embodiments;

FIG. 2A is a block diagram illustrating an example configuration of a system for generating the media presentation, according to various embodiments;

FIG. 2B is a diagram illustrating example modules/software components of a system for generating the media presentation, according to various embodiments;

FIG. 3 is a diagram illustrating an example process flow of identifying a region of interest in an image by an identification module of the system, according to various embodiments;

FIG. 4 is a diagram illustrating an example process flow of determining the region of interest in the image by a determining module of the system, according to various embodiments;

FIG. 5 is a diagram illustrating an example process flow for determining a geometric feature score for the region of interest in the image by a geometric feature sub-module of the system, according to various embodiments;

FIG. 6 is a diagram illustrating an example process flow for determining an image depth score for the region of interest by an image depth score sub-module of the system, according to various embodiments;

FIG. 7 is a diagram illustrating an example process flow for determining a zoomable score for the region of interest by a zoomable score sub-module of the system, according to various embodiments;

FIG. 8 is a diagram illustrating an example process flow for retrieving a consecutive image by a retrieving module of the system, according to various embodiments;

FIG. 9A is a diagram illustrating an example process flow of a dynamic global-local attention sub-module for determining a dynamic global local vector in the generating module of the system, according to various embodiments;

FIG. 9B is a diagram illustrating an example process flow for generating the consecutive image by the generating module of the system, according to various embodiments;

FIG. 10 is a diagram illustrating an example use-case for generating the media presentation, according to various embodiments; and

FIG. 11 is a flowchart illustrating an example method for generating the media presentation, according to various embodiments.

Those skilled in the art will appreciate that elements in the drawings are illustrated for simplicity and may not have necessarily been drawn to scale. For example, the flowcharts illustrate the method in terms of steps involved to help to improve understanding of aspects of the disclosure. Furthermore, in terms of the construction of the device, one or more components of the device may have been represented in the drawings by conventional symbols, and the drawings may show those specific details that are pertinent to understanding various embodiments of the disclosure so as not to obscure the drawings with details that will be readily apparent to those of ordinary skill in the art having the benefit of the description herein.

### DETAILED DESCRIPTION

Reference will now be made to various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect,” “another aspect” or similar language may refer, for example, to a particular feature, structure, or characteristic described in connection with an embodiment being included in at least one embodiment of the disclosure. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

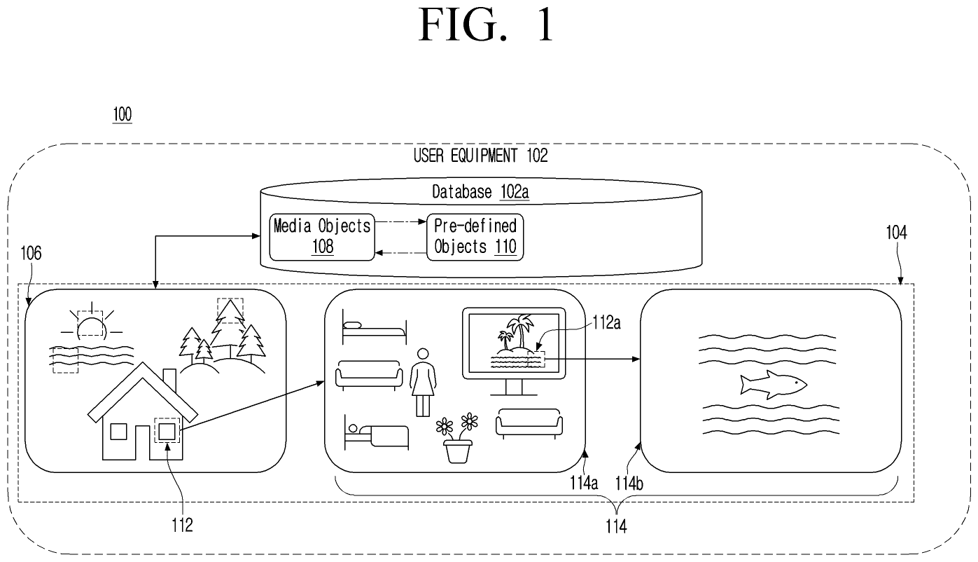

FIG. 1 is a diagram illustrating an example environment for the implementation of a system 100 for generating a media presentation 104, according to various embodiments. For the sake of brevity, the system 100 for generating the media presentation 104 is hereinafter interchangeably referred to as the system 100.

In an embodiment, referring to FIG. 1, the system 100 may be implemented in a user equipment (UE) 102. In an example, the UE 102 may be but not limited to, a laptop computer, a desktop computer, a Personal Computer (PC), a notebook, a smartphone, a tablet, a smart watch and the like.

In an embodiment, the system 100 may be implemented between a user (now shown) and the UE 102. In an example, the user desire to generate a media presentation 104 in the UE 102. The media presentation 104 is indicative of creating a slideshow between a plurality of media files such as images. The slideshow may include transitioning between the images with a zooming effect on a first image 106. The first image 106 may be the earliest image from where the slideshow initiates. In continuing the slideshow, a consecutive image is displayed, and the process may be repetitive to display the consecutive image one after another with an image continuity sequence and a semantic relevance between images.

While displaying the consecutive image in the form of the media presentation 104, a zoom-in effect is created in each of the image upon presentation. The zoom-in effect is created on an identified region of interest (ROI) 112a. There may be multiple ROIs 112 in the image. In an example, the first image 106 may have multiple ROIs 112 such as ROI-1, ROI-2, ROI-3, ROI-n. The system 100 may identify a zoomable ROI 112a from the multiple ROIs 112. The zoomable ROI 112a may then be selected for applying zoom-in effect before displaying the consecutive image 114. Such that application of zoom-in effect may create a transition illustrating that the consecutive image 114 originates from the zoomable ROI 112a.

As illustrated in FIG. 1, in an example, the first image 106 may be selected by the user from a database 102a of the UE 102 or alternatively the user may capture the first image 106 using a camera of the UE 102 such that the UE 102 may be a source of the first image 106. The database 102a may include storing a media object 108 such as a cluster of images stored in the database 102a. In the example, the media object 108 may provide the first image 106 and any consecutive image(s) 114. The database 102a may also include a predefined (e.g., specified) object 110 corresponding to the media object 108. In the example, the predefined object 110 may be known set of objects present in the media object 108. In the example, the first image 106 may include plurality of the pre-defined objects 110 such as a sun, a house, a tree. A dotted line bounding box is created on each of the pre-defined (e.g., specified) objects 110 in the first images identifying them as multiple ROIs.

In an embodiment, the zoomable ROI 112a is determined from the multiple ROIs in the first image 106. In an example, a window in the house, in the first image 106 is determined. A zoom-in effect is applied on the window being the zoomable ROI 112a and subsequently the consecutive image 114 is displayed. In the example, the consecutive image 114a may be displayed after zooming in on the zoomable ROI 112a e.g., the window. The consecutive image 114a may represent a room set-up which may contextually be relevant to the first image 106 and the zoomable ROI 112a. In this instance, the window is selected as the zoomable ROI 112a and the zoom-in effect may be applied on the window, thus it may be contextually relevant to display the room set-up depicted in the consecutive image 114a. Similarly, now the zoomable ROI 112a is determined in the consecutive image 114a being the room scenario. In the example, the zoomable ROI 112a in the consecutive image 114a may be determined as a river scene in a painting present in the room scenario. Thus, the zoom-in effect is applied on the zoomable ROI 112a e.g., the river scene and the consecutive image 114b is displayed. In the example, the consecutive image 114b displaying a fish in river may be contextually relevant as the painting in the previous consecutive image 114a displays the river scene. Such process of determining the zoomable ROI 112a in each image and presenting the consecutive image 114 continues until the user ends transition, the media objects 108 in the database 102a is exhausted, or contextually the system 100 may cease to generate any consecutive image 114.

The user may provide instructions to the UE 102 for generating the media presentation 104 via an application installed in the UE 102. The application may be used for receiving instructions from the user and generating the media presentation 104 using a processor of the system 100.

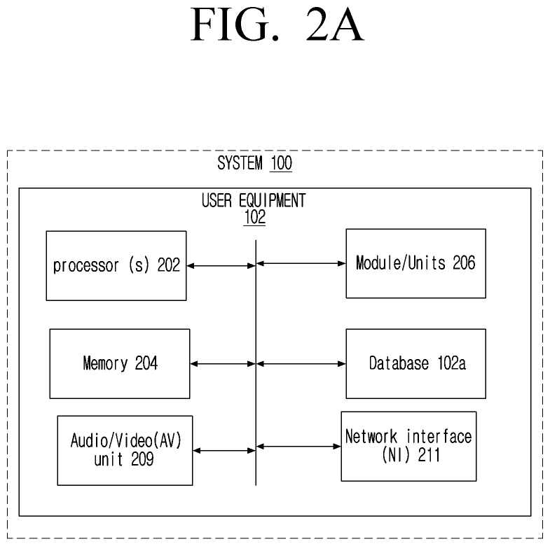

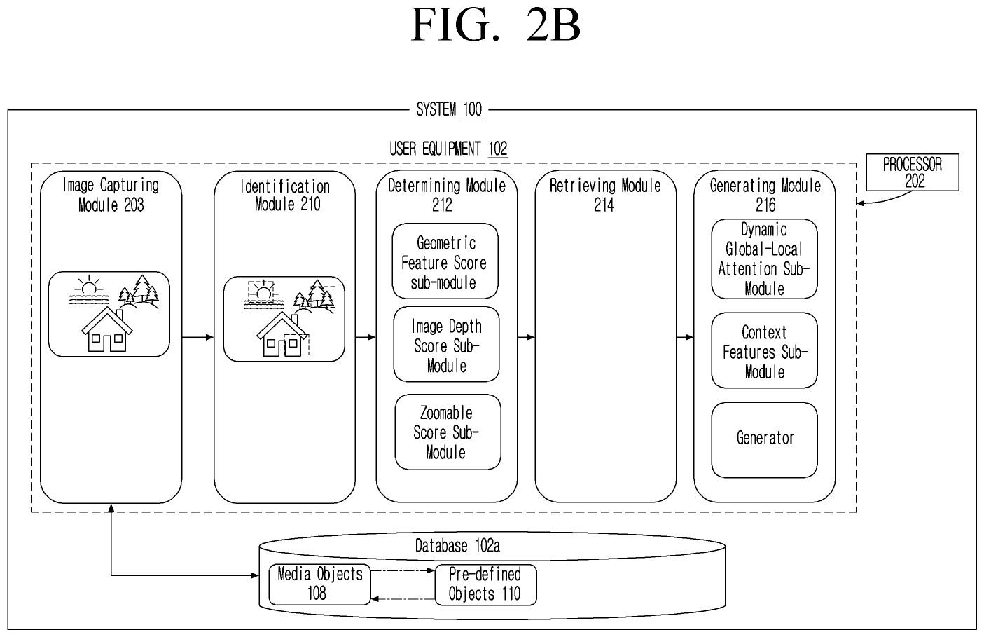

FIG. 2A is a block diagram illustrating an example configuration of the system 100 for generating the media presentation 104 according to various embodiments. According to an embodiment, the system 100 includes at least one or more processors (e.g., including processing circuitry) 202, a memory 204, a module/unit (e.g., including various circuitry and/or executable program instructions executed on the circuitry) 206, the database 102a, an audio/video (AV) unit (e.g., including A/V circuitry) 209, a Network Interface (NI) 211 coupled with each other. The system 100 may be further coupled with a server 215 via an internet 213 (not shown).

FIG. 2B is a diagram illustrating example modules/software components of the system 100 for generating the media presentation 104 according to various embodiments.

In an embodiment, referring to FIGS. 2A and 2B, the UE 102 may include, but is not limited to, a processor (e.g., including processing circuitry) 202, memory 204, modules (e.g., including various circuitry and/or executable program instructions executed on various circuitry) 206, and database 102a. The modules 206 and the memory 204 may be coupled to the processor 202.

The processor 202 may include various processing circuitry, for example, a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is adapted to fetch and execute computer-readable instructions and data stored in the memory 204. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Further, the processor 202 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

A detailed explanation of each of the aforesaid component as shown in FIGS. 2A and 2B will be explained in greater detail below. Further, the working of the system 100 will be explained with respect to FIGS. 2A and 2B. The reference numerals are kept the same in the disclosure wherever applicable for the ease of explanation.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The modules 206, amongst other things, may include various circuitry and/or routines, programs, objects, components, data structures, etc., which perform particular tasks or implement data types and may be executed by the various circuitry. The modules 206 may also be implemented as, signal processor(s), state machine(s), logic circuitries, and/or any other device or component that manipulates signals based on operational instructions.

The modules 206 can be implemented in hardware, instructions executed by a processing unit, or by a combination thereof. The processing unit can comprise a computer, a processor (see, e.g., description above), a state machine, a logic array, or any other suitable devices capable of processing instructions. The processing unit can be a general-purpose processor which executes instructions to cause the general-purpose processor to perform the required tasks or, the processing unit can be dedicated to performing the required functions. In an embodiment of the present disclosure, the processor 202 includes the modules 206 and the processor 202 via the modules 206 is configured to execute machine-readable instructions (software) which perform the working of the system 100 within the scope of the disclosure as described in forthcoming paragraphs.

In an embodiment, the modules 206 may include an image capturing module 203, an identification module 210, a determining module 212, a retrieving module 214, and a generating module 216. The identification module 210, the determining module 212, the retrieving module 214, and the generating module 216 may be in communication with each other. The data 208 serves, amongst other things, as a repository for storing data processed, received, and generated by one or more of the modules 206.

Referring to FIGS. 1, 2A and 2B, the image capturing module 203 is configured to capture the first image 106 via a camera installed in the UE 102. Alternatively, the image capturing module 203 is in communication with the database 102a and is configured to retrieve the first image 106 which may be stored in the media objects 108.

In an embodiment, the identification module 210 is configured to receive the first image 106 from the media objects 108 or from the image capturing module 203. The first image 106 may include a pre-defined objects 110. Further, the identification module 210 is configured to identify multiple ROIs 112 e.g., ROI-1, ROI-2, ROI-3, ROI-n in the first image 106 based on the pre-defined objects 110. The identification module 210 is in communication with the determining module 212.

In an embodiment, the determining module 212 may be configured to determine the zoomable ROI 112a among the identified multiple ROIs 112. The determining module 212 is configured to determine pre-defined object's shape and state score such as zoomable score to determine the zoomable ROI 112a from the identified multiple ROIs 112 in the first image 106. In an example, the zoom-in effect may be applied on the zoomable ROI 112a. The identification module 210 and the determining module 212 is in communication with the retrieving module 214.

In an embodiment, the retrieving module 214 may be configured to retrieve the consecutive image 114 from the media objects 108 based on the zoomable ROI 112a. The consecutive image 114 is displayed such that the media presentation 104 is created with the zoom-in effect applied on the zoomable ROI 112a, upon presentation with image continuity sequence and semantic relevance between the first image 106 and the consecutive image 114. The identification module 210, the determining module 212, and the retrieving module 214 is in communication with the generating module 216.

In an embodiment, the generating module 216 may be configured to generate the consecutive image 114 based on the zoomable ROI 112a. In an example, the generating module 216 may generate the consecutive image 114 upon failure of the retrieving module 214 to retrieve the consecutive image 114 from the media objects 108. Further, the generating module 216 may be configured to embed the consecutive image 114 with the first image 106 for generating the media presentation 104. In an embodiment, a graphics processor such as the graphics processing unit (GPU) may include the generating module 216 and such graphics processor may be configured to perform working of the system 100 with respect to the generating module 216.

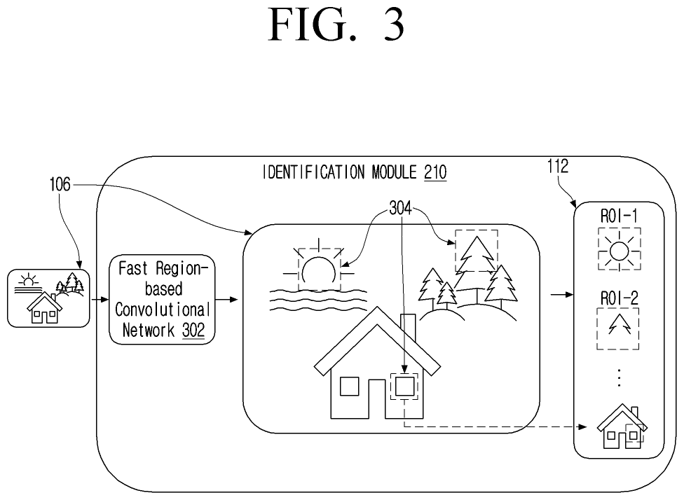

FIG. 3 is a diagram illustrating an example process of identifying the ROIs 112, e.g., ROI-1, ROI-2, ROI-3, ROI-n in the first image 106 by the identification module 210 of the system 100, according to various embodiments.

In an embodiment, the identification module 210 of the system 100 may include Fast Region-based Convolutional Neural Network 302 (Fast-RCNN) for performing object detection techniques on the first image 106. In an example, the identification module 210 may, for example, and without limitation, use a CNN based architecture such as VGG or ResNet followed by a pooling layer. The output of the pooling layer may be input to a fully connected layer to predict bounding boxes 304 around the identified ROIs 112 e.g., ROI-1, ROI-2, ROI-3, ROI-n in the first image 106. Similarly, the ROIs 112 identification may be performed in the consecutive image 114 as well.

Once the ROIs 112 are identified, the identification module 210 may be configured to slice each of the ROI-1. ROI-2, ROI-3, ROI-n from the first image 106 and store in the database 102a. A feature vector corresponding to each of the identified ROIs 112 is derived from an output layer of the Fast-RCNN 302. In an example, the feature vector may be represented as: Let R∈{r₁, r₂ . . . rₙ} for n number of ROIs 112.

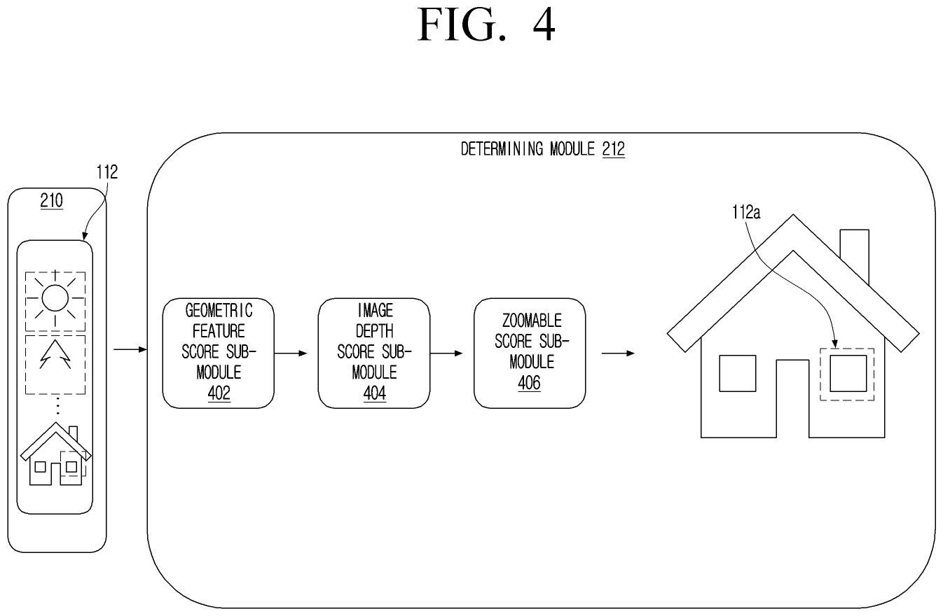

FIG. 4 is a diagram illustrating an example process of determining the zoomable ROI 112a in the first image 106 by the determining module 212 of the system 100, according to various embodiments.

In an embodiment, the determining module 212 may be configured to determine the zoomable ROI 112a from the identified ROIs 112. The determining module 212 may include a geometric feature score sub-module 402, an image depth score sub-module 404, a zoomable score sub-module 406. In an example, the identified ROIs 112 are received as input by the determining module 212 for calculating such scores by the sub-modules and determining the zoomable ROI 112a based on score.

In an example, the geometric feature score sub-module 402 may be configured to determine a geometric feature score based on shape of each of the ROIs 112 such as circle, ellipses, polygon, rectangle, triangle. The bounding box around each of the ROIs 112 may include object class and region information.

In an example, the image depth score sub-module 404 may be configured to determine an image depth in geometric selected object.

In an example, the zoomable score sub-module 406 may be configured to determine a zoomable score for each of the ROIs 112 based on the geometric feature score, the image depth score, and finally determine the zoomable ROI 112a.

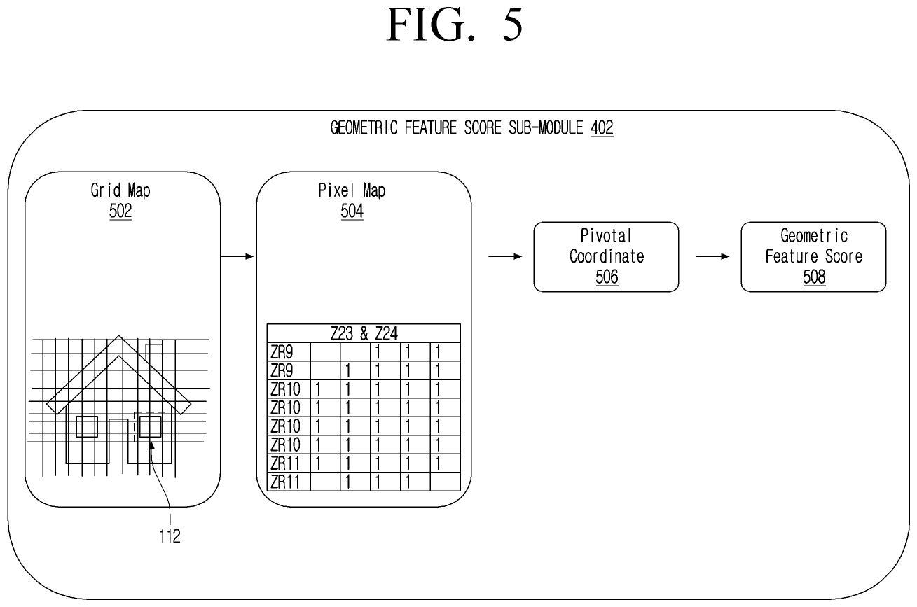

FIG. 5 is a diagram illustrating an example process for determining the geometric feature score for the ROIs 112 in the first image 106 by the geometric feature sub-module 402 of the system 100, according to various embodiments.

In an embodiment, the geometric feature sub-module 402 is configured to determine a dimension for the ROIs 112. A grid map 502 is determined for the ROIs 112 identified in the first image 106. The grid map 502 is determined based on the dimension. In an example, the grid map 502 indicates partitioning each of the ROIs 112 into multiple grid segments such that the grid map 502 partition each of the ROIs 112 into a multiple set of pixels or a number of objects or a number of small images to fit into the grid map 502. Further, the grid map 502 is mapped into multiple zones. The multiple zones may be indicative of a columnar location for each of the grid segments. For example, in one of the ROIs 112 the object being the window may be present at a certain grid segment of the grid map. Now to identify the grid segment for the window, the zone may be determined such that it indicates a coordinate or columnar location of the window.

In an embodiment, the geometric feature sub-module 402 is configured to determine a pixel map 504 for each of the ROIs 112 based on the grid map 502. In an example, the pixel map 504 may form a table including a pixel information of the zone corresponding to each of the ROIs 112. In an example, the ROIs 112 is transformed into the pixel map of 24 bits retaining true colours. In the example, the pixel map 504 may correspond to the zone in which the window being the object in one of the ROIs 112 may be present.

The geometric feature sub-module 402 is configured to determine an association between the grid segments based on the grid map 502 and the pixel map 504. The association may be indicative of distribution of geometric relationships within zones that relates to the grid map 502. In an example, if the window being the object in one of the ROIs 112, may be present in multiple zones of the grid segment then, the association between the grid segments is determined such that all multiple zones sharing common boundary edges are included in determining the pixel map 504 for the window.

The geometric feature sub-module 402 is configured to determine a pivotal coordinate 506 for each of the zones. In an example, the pivotal coordinate indicates a starting and an ending point of each of the zone in the grid map 502. Such coordinates may also be considered for deducing a geometric features for identified ROIs 112. The geometric feature score 506 is thus determined based on the grid map 502, the pixel map 504, the association between the plurality of grid segments, and the pivotal coordinate 506. In an example, the geometric feature score 506 may associate relevance of the ROIs 112 with a shape of the object. In an example, the geometric feature score 506 of the window being the object in one of the ROIs 112 is relevant to shape such as circle, ellipses, polygon, rectangle, triangle, etc.

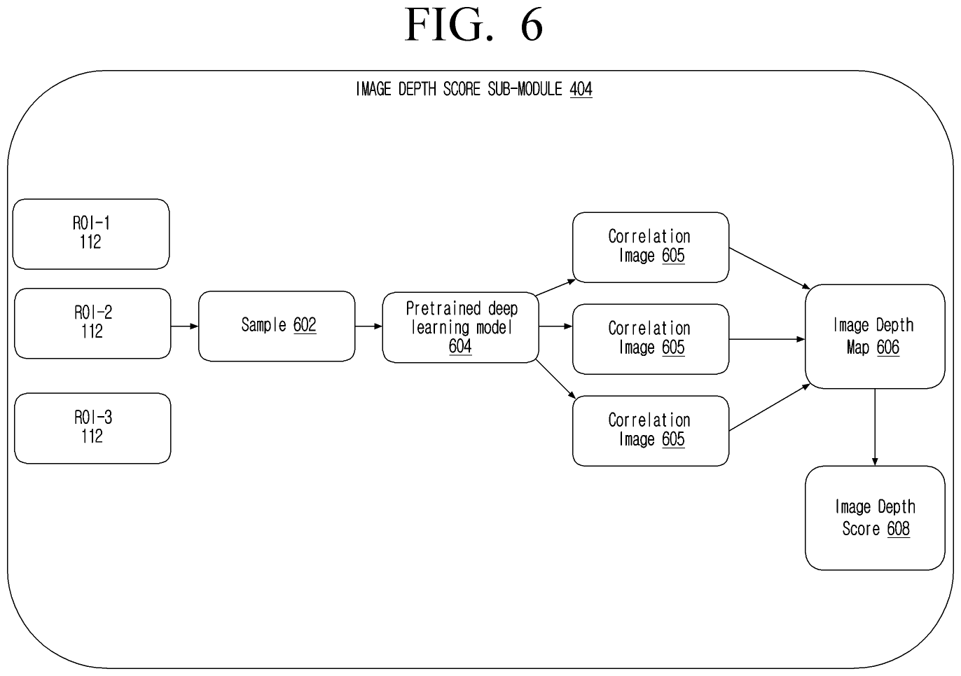

FIG. 6 is a diagram illustrating an example process for determining an image depth score 608 for the ROIs 112 by an image depth score sub-module 404 of the system 100, according to various embodiments.

In an embodiment, the image depth score sub-module 404 may be configured to sample 602 the ROIs 112 to determine a geometry of each of the ROIs in the first image 106. In an example, sample 602 is indicative of dividing each of the ROIs 112 into n number of parts or tiles to distinguish the geometry of the object. In an example, the window in one of the ROIs 112 may be divided into N×N tiles to preserve position of the window in the ROI.

The image depth score sub-module 404 may include a pretrained deep learning model 604 such as ResNet-50. The pretrained deep learning model 604 is used to extract feature vector from each of the ROIs 112.

The image depth score sub-module 404 may be configured to determine a correlation image 605 and an image depth map 606 for the correlation image 605 based on the extracted features. In an example the correlation image 605 may be structurally equivalent to the ROIs 112. In the example, K-Nearest Neighbor framework may be applied to determine the correlation image 114. In the example, the correlation image 605 may be retrieved from the database 102a.

The image depth score sub-module 404 may be configured to determine a correlation value for the correlation image 605. In an example, one or more correlation images 605 are determined which be structurally equivalent to the ROIs 112 then only one of the correlation image 605 is selected with the correlation value higher than a pre-defined correlation coefficient. The analysis of correlation value may remove outliers from the determined one or more correlation images 605 and may further reduce the number of determined correlation image 605.

In an embodiment, the image depth score sub-module 404 may be configured to determine the image depth map 606 for the ROIs 112. In an example, the image depth map 606 for the ROIs 112 is determined corresponding to the depth map of the correlation image 605 which is structurally similar to the ROI. Thus, the image depth score 608 is determined based on the determined image depth map 606. The image depth score 608 may signify the accuracy of the ROIs 112 with the selected correlation image 605.

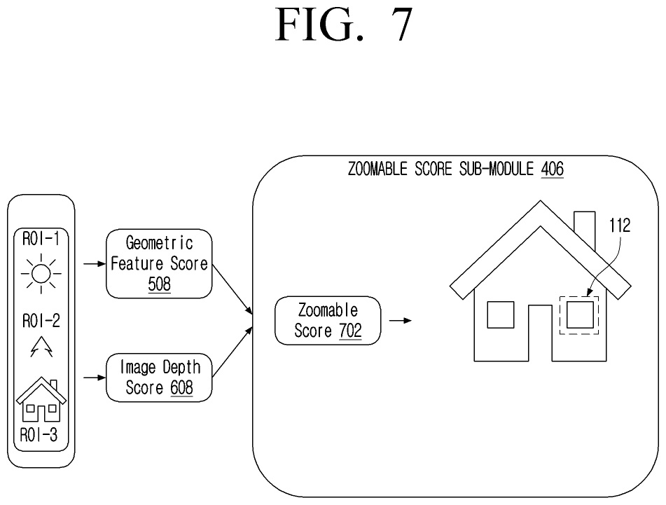

FIG. 7 is a diagram illustrating an example process for determining a zoomable score 702 for the ROIs 112 by a zoomable score sub-module 406 of the system 100, according to various embodiments.

In an embodiment, the zoomable score sub-module 406 is configured to determine the zoomable ROI 112a, so as to remove other ROIs 112, based on the geometric feature score 508 and the image depth score 608. In an example, the zoomable score sub-module 406 may be a fusion decision model configured to receive the geometric feature score 508 (see, e.g., FIG. 5) and the image depth score 608. The combination of the geometric feature score 508 and the image depth score 608 may be passed through a fully connected layer in the zoomable score sub-module 406 to determine the zoomable score 702 also classify the probable object class of the zoomable ROI 112a thus selected based on the highest zoomable score 702.

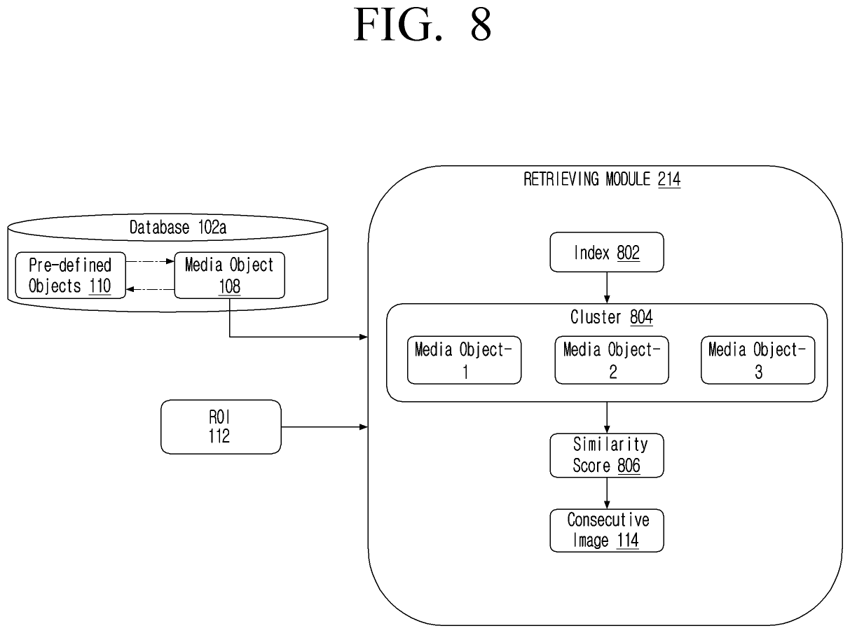

FIG. 8 is a diagram illustrating an example process for retrieving the consecutive image 114 by the retrieving module 214 of the system 100, according to various embodiments.

In an embodiment, the retrieving module 214 is configured to search and retrieve consecutive image 114 from the database 102a such as phone gallery in minimal time with high accuracy. In an example, the retrieving module 214 is configured to index 802 the media object 108 in the database 102a. For example, Self-Organizing Map (SOM) may be used as a technique for indexing the media object 108.

The retrieving module 214 is configured to prepare a cluster 804 for the media object 108. The cluster 804 prepared with the media object 108 may signify that the media objects 108 present in the cluster 804 may have visually similar features with the first image 106. The cluster 804 is indicative of classifying the media objects 108 into a given number of categories. The cluster 804 may use unsupervised machine learning techniques wherein the media object 108 with similar features are grouped together. In an example, k-means clustering, and spectral clustering may be used in the retrieving module 214 to prepare the cluster 804. Thus, the retrieving module 214 is configured to determine an association between the zoomable ROI 112a and the media object 108 based on the clustering 804. In an example, the K-Nearest Neighbor supervised learning may be used to determine association between the at least one zoomable ROI and the plurality of media objects in each of the plurality of clusters.

The retrieving module 214 is configured to determine a similarity score 806 for each of the media objects 108 in cluster 804 based on the association and retrieve one of the media object 108 as the consecutive image 114 from the plurality of clusters based on the highest similarity score 806.

Thus, the zoom-in effect is applied on the determined zoomable ROI 112a and the consecutive image 114 determined from the database 102a is displayed.

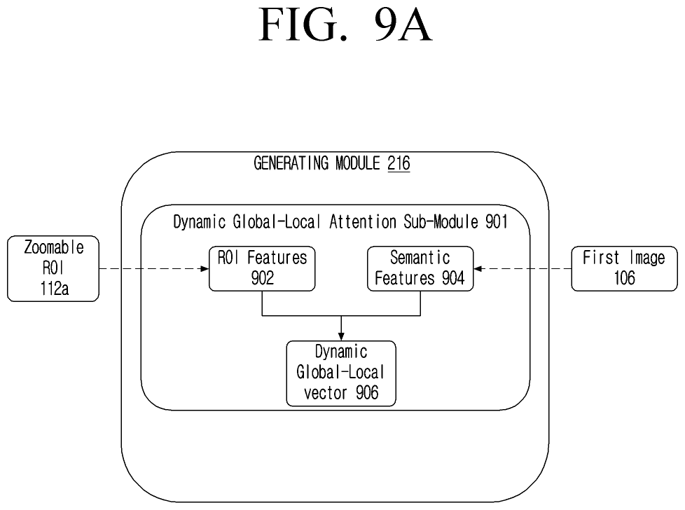

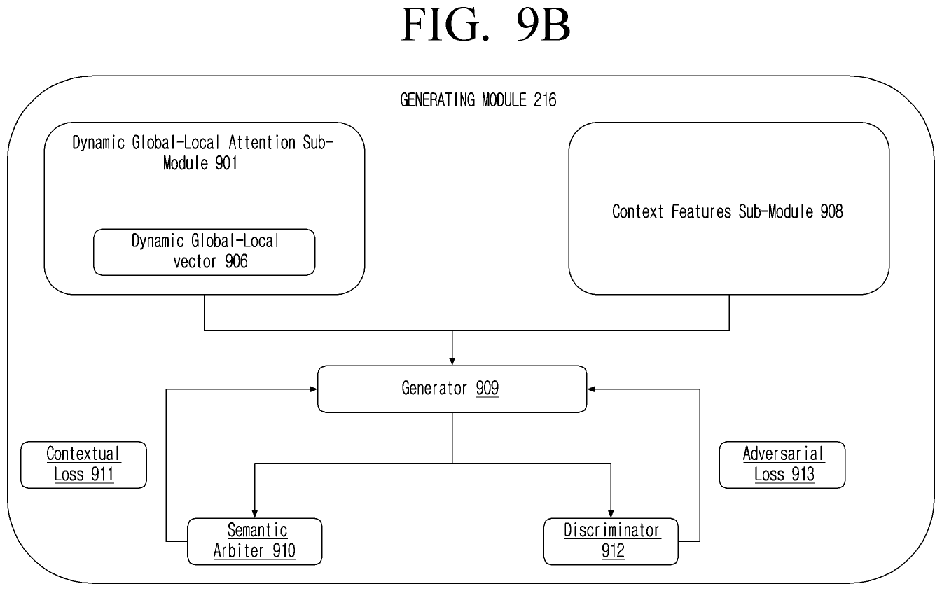

FIG. 9A is a diagram illustrating an example process for a dynamic global-local attention sub-module for determining a dynamic global local vector in the generating module 216 of the system 100, according to various embodiments.

In an embodiment, the generating module 216 is configured to generate the consecutive image 114 based on the zoomable ROI 112a. The consecutive image 114 is generated when the retrieving module 214 fails to retrieve the consecutive image 114 from the media objects 108 in the database 102a. Further, the generating module 216 embed the generated consecutive image 114 with the first image 106 for generating the media presentation 104 such that the zoom-in effect is created on the zoomable ROI 112a and subsequently the consecutive image 114 is displayed on the UE 102.

In various embodiments, the generating module 216 includes the dynamic global-local attention sub-module 901. The dynamic global-local attention sub-module 901 is configured to guide the generating module 216 in determining local and global saliency features of the zoomable ROI 112a and the first image 106. The dynamic global-local attention sub-module 901 may adjust the importance of local features such as features derived from the zoomable ROI 112a and using the global features such as any semantic features derived from the first image 106. In an example, the dynamic global-local attention sub-module 901 may include a dual global-local attention processes to extract a ROI feature 902 and a semantic feature 904 respectively.

In an example, one of the dual global-local attention processes may be configured to extract from the ROI feature 902 to measure the importance of the first image 106. In the example, the ROI feature 902 may be indicative of the object in the zoomable ROI 112a such as the window. Similarly, another of the dual global-local attention processes may be configured to extract semantic feature 904 from the first image 106 to measure the importance of the ROI feature 902. In the example, the semantic features 904 may be indicative of shape, color, size, texture of the object in the zoomable ROI 112a.

In various embodiments, the dynamic global-local attention sub-module 901 is configured to concatenate the ROI feature 902 and the semantic feature 904 to determine a representation of the zoomable ROI 112a. The representation thus determines a dynamic global-local attention vector 906.

FIG. 9B is a diagram illustrating an example process for generating the consecutive image 114 by the generating module 216 of the system 100, according to various embodiments.

In an embodiment, the generating module 216 includes the dynamic global-local attention sub-module 901 and the context feature sub-module 907. In an example, context may refer, for example, to the objects and concepts that appear in the image. Context may provide information about particular scene in image such as objects in image, their arrangement, relative physical size to other objects, and location. In the example, the context feature sub-module 907 may be a type of recurrent neural network configured to determine a context feature 908 from the first image 106. In another example, the context feature sub-module 907 may be configured to determine the context feature 908 from a text provided as input by the user. In another instance, user's environmental context or environmental context in the first image may be determined as the context feature 908 such as a sunset, a rainfall. Thus, the context feature 908 may assist in generating multiple possibilities for the consecutive image 114.

The dynamic global-local vector 906 and the context feature 908 are provided as input to a generator 909. Further, the generating module 216 includes a generative adversarial network (GAN) architecture including the generator 909, a semantic arbiter 910 and a discriminator 912 forming convolutional neural network for generation of the consecutive image 114.

In an embodiment, the generator 909 may be a temporal generator neural network that models a transform function. In an example, the generator 909 may be configured to generate the consecutive image 114 based on the context feature 908 and the dynamic global-local attention vector 906. Thus, the generated consecutive image 114 is contextually correct succeeding image in sequence with input image which in the instance is the first image 106. It will be understood that input image varies at different instances such as the generated consecutive image 114 may become input image further in the process for which contextually correct succeeding image is to be generated. Thus, the generator 909 is configured to generate contextual image which is in sequence with input image.

In an embodiment, the semantic arbiter 910 may be configured to assess the generated consecutive image 114 in terms of quality and sequential semantics with respect to input image which in the present instance is the first image 106. The semantic arbiter 910 may be configured to determine a contextual loss 911 by comparing sequential semantics of the generated consecutive image 114 with the first image 106. Further in accordance with the contextual loss 911 the weights for the generator 909 are adjusted.

In an embodiment, the discriminator 912 is a classifier that may distinguish real data from the data created by the generator 909. The discriminator 912 may be trained using real data instances or fake data instances created by the generator 909. In an instance, the discriminator 912 is configured to distinguish between consecutive images originating from training dataset with generated consecutive images 114 to assess a loss function such as an adversarial loss 913. In the instance, the generator 909 and the discriminator 912 may use minimax GAN loss referring to the minimax simultaneous optimization of the discriminator and generator models. Further in accordance with the adversarial loss 913 the weights for the generator 909 are adjusted.

Using the contextual loss 911 and the adversarial loss 913, a combined loss function is derived and the generator 909 may be trained based on the combined loss function. Thus, the generator 909 may adjust weights in accordance with the contextual loss 911 and the adversarial loss 913 to generate the consecutive image 114. Further, the generated consecutive image 114 may thus be displayed on the UE 102 such that the media presentation 104 creates the zoom-in effect upon presentation with the image continuity sequence and the semantic relevance.

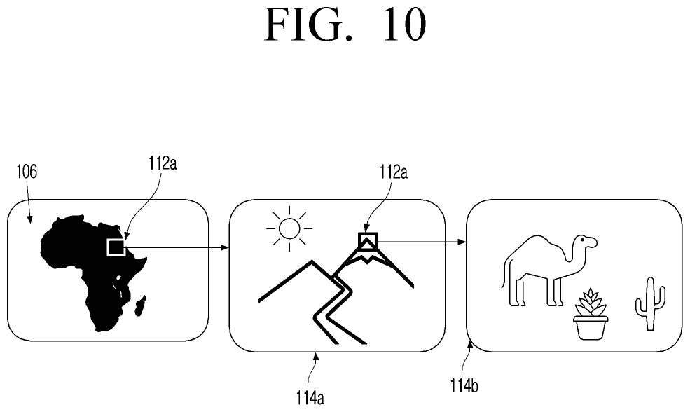

FIG. 10 is a diagram illustrating an example use case for generating the media presentation 104, according to various embodiments.

In various embodiments, the first image 106 may display a world map. The zoomable ROI 112a is determined in the first image 106 e.g., a city in the world map. The zoom-in effect is created on the zoomable ROI 112a e.g., the city illustrated as a bounding box. The consecutive image 114a is displayed. The consecutive image 114a illustrates a landscape scene in the city. Thus, creating a semantically, contextually relevant consecutive image 114. The consecutive image 114a may act as input image for the generating module 216 and the zoombale ROI 112a e.g., a peak of mountain is determined in the consecutive image 114a, which is illustrated with the bounding box. The zoom-in effect is created on the zoombale ROI 112a in the consecutive image 114a and the consecutive image 114b is displayed. The consecutive image 114b illustrates animals and plants which may be semantically, contextually relevant to previous image e.g., the consecutive image 114a.

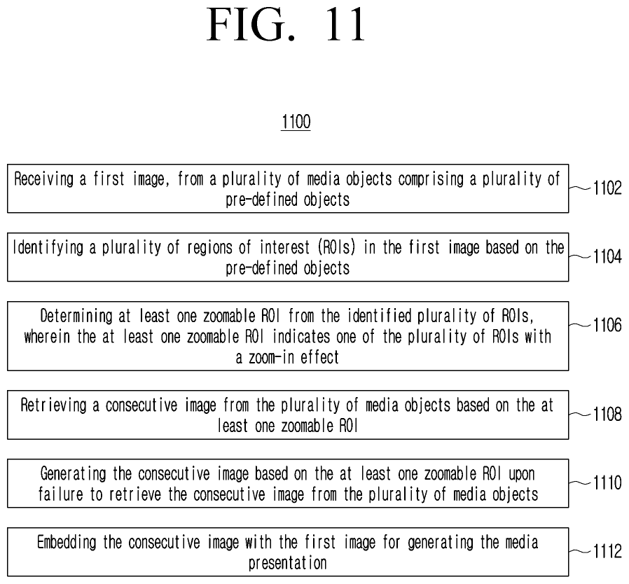

FIG. 11 is a flowchart illustrating an example method 1100 for generating the media presentation 104, according to various embodiments. The method 1100 may be a computer-implemented method executed, for example, by the UE 102 and the modules 206. For the sake of brevity, constructional and operational features of the system 100 that are already explained in the description of FIGS. 1, 2A, 2B, 3, 4, 5, 6, 7, 8, 9A, 9B and 10 may not be repeated in the description of FIG. 11.

At step 1102, the method 1100 may include receiving the first image 106, from the media object 108 stored in the database 102a. The database 102a may also include the pre-defined object 110 in the media object 108.

At step 1104, the method 1100 may include identifying the ROIs 112 in the first image 106 based on the pre-defined objects 110.

At step 1106, the method 1100 may include determining the zoomable ROI 112a from the identified ROIs 112. The zoomable ROI 112a indicates one of the ROIs 112 with a zoom-in effect. The method 1100 may include determining the geometric feature score 508 for each of the ROIs 112. The geometric feature score 508 is indicative of a geometric classification of each of the ROIs 112. In an example, the method 1100 for determining the geometric feature score 508 may include determining a dimension of each of the ROIs 112. The method 1100 may include determining the grid map 502 for each of the ROIs 112 based on the dimension. The grid map 502 may be indicative of partitioning the ROIs 112 into a plurality of grid segments. The method 1100 may include mapping the grid map 502 into the zones. The zones may be indicative of columnar location of each of the grid segments. The method 1100 may include determining the pixel map 504 for each of the ROIs 112 based on the grid map. In the method 1100 the pixel map 504 includes the pixel information of the zones corresponding to each of the ROIs 112. The method 1100 may include determining the association between the grid segments based on the grid map 502 and the pixel map 504. Further, the method 1100 may include determining a pivotal coordinate 506 for each of the zones, wherein the pivotal coordinate 506 indicates the starting and the ending point of each of the zones and the geometric feature score 508 is determined based on the grid map 502, the pixel map 504, the association between the plurality of grid segments, and the pivotal coordinate 506.

In an embodiment, the method 1100 may include determining the image depth score 608 for each of the ROIs 112. The image depth score 608 is indicative of the image depth classification of each of the ROIs 112. In an example, the first image 106 is sampled 602 to determine a position of the pre-defined objects in the first image 106. The method 1100 may include extracting features from the sampled first image 106 using the pretrained machine learning model 604. Further, the correlation images 605 are determined and the image depth map 605 is determined for each of the correlation images 605 based on the extracted features. In the example, the correlation image 605 is structurally equivalent to the first image 106. The method 1100 may include determining a correlation value of each of the correlation images 605 to select at least one correlation image 605 with the correlation value higher than the pre-defined correlation coefficient. The method 1100 may include determining the image depth map 606 for the first image 106 based on the image depth map of the selected at least one correlation image 605 and further determining the image depth score 608 based on the determined image depth map 606.

In an embodiment, the method 1100 may include determining the zoomable score 702 for each of the ROIs 112 based on the geometric feature score 508 and the image depth score 608. The method 1100 may include determining the zoomable ROI 112a based on the zoomable score 702.

At step 1108, the method 1100 may include retrieving the consecutive image 114 from the media objects 108 based on the zoomable ROI 112a.

In an embodiment, for retrieving the consecutive image 114 from the database 102a the method 1100 may include indexing 802 the media objects 108 stored in the database 102a. Further, preparing the clusters 804 comprising of the media objects 108 such that the media objects 108 may be having visually similar features with that of the ROIs 112. The method 1100 may include determining the association between the first image 106 and the media objects 108 in each of the clusters 804. A similarity score is determined for each of the media objects 108 in the cluster 804 based on the association and one of the media object 108 is retrieved as the consecutive image 114 from the cluster 804 based on the similarity score 806.

At step 1110, the method 1100 may include generating the consecutive image 114 based on the zoomable ROI 112a upon failure to retrieve the consecutive image 114 from the media object 108.

In an embodiment, the method 1100 may include extracting the ROI feature 902 from the zoomable ROI 122a. In an example, the ROI feature 902 is indicative of the object in the zoomable ROI 122a.

The method 1100 may include extracting the semantic feature 904 from the first image 106. In the example, the semantic feature 904 is indicative of shape, color, size, texture of the object in the zoomable ROI 112a. The method 1100 may include concatenating the ROI feature 902 and the semantic feature 904 to determine the representation of the zoomable ROI 112a. Further, the context feature 908 based on the first image 106 and the user's environmental context is determined. The dynamic global-local attention vector 906 is determined from the first image 106 based on the ROI feature 902 and the semantic feature 904. The method 1100 may include generating the consecutive image 114 based on the context feature 908 and the dynamic global-local attention vector 906.

In an embodiment, the method 1100 may include determining the generation loss through the semantic arbiter 910 by comparing the generated consecutive image 114 sequential semantics with the first image 106.

At step 1112, the method 1100 may include embedding the consecutive image 114 with the first image 106 for generating the media presentation 106. In an embodiment, the zoom-in effect is created on the zoomable ROI 112a. Further, the consecutive image 114 is displayed on the UE 102 such that the media presentation 104 creates the zoom-in effect upon presentation with the image continuity sequence and the semantic relevance.

The disclosure provides various example, non-limiting, advantages:
The disclosure enables the user to create engaging content for viewing.
The disclosure provides zooming transition ability in a slideshow of images.
The disclosure includes using machine learning techniques to retrieve images from the database which may be semantically and contextually relevant with respect to input image. Thus, manual efforts and time of the content creator is saved.
The disclosure includes using machine learning techniques to generate semantically and contextually relevant with respect to input image. Thus, the content creator may not have to be dependent on manual sorting, searching.

While specific language has been used to describe the disclosure, any limitations arising on account of the same are not intended. As would be apparent to one skilled in the art, various working modifications may be made to the method in order to implement the concept as taught herein.

The drawings and the forgoing description give examples of various embodiments. Those skilled in the art will appreciate that one or more of the described elements may well be combined into a single functional element. Various elements may be split into multiple functional elements. Elements from one embodiment may be added to another embodiment. For example, orders of processes described herein may be changed and are not limited to the manner described herein.

While the disclosure has been illustrated and described with reference to various example embodiments, it will be understood that the various embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for generating a media presentation, the method comprising:
receiving a first image, from a plurality of media objects comprising a plurality of specified objects;
identifying a plurality of regions of interest (ROIs) in the first image based on the specified objects;
determining at least one zoomable ROI from the identified plurality of ROIs, wherein the at least one zoomable ROI includes one of the plurality of ROIs with a zoom-in effect;
retrieving a consecutive image from the plurality of media objects based on the at least one zoomable ROI;
generating the consecutive image based on the at least one zoomable ROI based on a failure to retrieve the consecutive image from the plurality of media objects; and
embedding the consecutive image with the first image to generate the media presentation.

2. The method as claimed in claim 1, comprising generating the media presentation using a convolutional neural network (CNN).

3. The method as claimed in claim 1, wherein determining the at least one zoomable ROI comprises:
determining a geometric feature score for each of the plurality of ROIs, wherein the geometric feature score is indicative of a geometric classification of each of the plurality of ROIs;
determining an image depth score for each of the plurality of ROIs, wherein the image depth score is indicative of an image depth classification of each of the plurality of ROIs;
determining a zoomable score for each of the plurality of ROIs based on the geometric feature score and the image depth score; and
determining the at least one zoomable ROI based on the zoomable score.

4. The method as claimed in claim 3, wherein determining the geometric feature score comprises:
determining a dimension of each of the plurality of ROIs;
determining a grid map for each of the plurality of ROIs based on the dimension, wherein the grid map indicates partitioning each of the plurality of ROIs into a plurality of grid segments;
mapping the grid map into a plurality of zones, wherein the plurality of zones is indicative of columnar location of each of the plurality of grid segments;
determining a pixel map for each of the plurality of ROIs based on the grid map, wherein the pixel map comprising pixel information of the plurality of zones corresponding to each of the plurality of ROIs;
determining an association between the plurality of grid segments based on the grid map and the pixel map,
determining a pivotal coordinate for each of the plurality zones, wherein the pivotal coordinate indicates a starting and an ending point of each of the plurality of zones; and
determining the geometric feature score based on the grid map, the pixel map, the association between the plurality of grid segments, and the pivotal coordinate.

5. The method as claimed in claim 3, wherein determining the image depth score comprises:
sampling the first image to determine a position of each of the plurality of specified objects in the first image;
extracting features from the sampled first image using a trained machine learning model;
determining a plurality of correlation images and an image depth map of each of the plurality of correlation images based on the extracted features, wherein the plurality of correlation images is structurally equivalent to the first image;
determining a correlation value of each of the plurality of correlation images to select at least one correlation image with the correlation value higher than a specified correlation coefficient;
determining the image depth map for the first image based on the image depth map of the selected at least one correlation image; and
determining the image depth score based on the determined image depth map.

6. The method as claimed in claim 1, wherein retrieving the consecutive image from the plurality of media objects comprises:
indexing the plurality of media objects stored in a database;
preparing a plurality of clusters comprising of the plurality of media objects, based on the plurality of media objects with visually similar features;
determining an association between the first image and the plurality of media objects in each of the plurality of clusters;
determining a similarity score for each of the plurality of media objects in each of the plurality of clusters based on the association; and
retrieving one of the plurality of media objects, as the consecutive image from the plurality of clusters based on the similarity score.

7. A system for generating a media presentation, the system comprising:
at least one processor, comprising processing circuitry, individually and/or collectively, configured to:
receive a first image, from a plurality of media objects comprising a plurality of specified objects;
identify a plurality of regions of interest (ROIs) in the first image based on the specified objects;
determine at least one zoomable ROI from the identified plurality of ROIs, wherein the at least one zoomable ROI includes one of the plurality of ROIs with a zoom-in effect;
retrieve a consecutive image from the plurality of media objects based on the at least one zoomable ROI;
generate the consecutive image based on the at least one zoomable ROI based on a failure to retrieve the consecutive image from the plurality of media objects; and
embed the consecutive image with the first image to generate the media presentation.

8. The system as claimed in claim 7, wherein at least one processor, individually and/or collectively, is configured to generate the media presentation using a convolutional neural network (CNN).

9. The system as claimed in claim 7, wherein at least one processor, individually and/or collectively, is configured to:
determine a geometric feature score for each of the plurality of ROIs, wherein the geometric feature score is indicative of a geometric classification of each of the plurality of ROIs;
determine an image depth score for each of the plurality of ROIs, wherein the image depth score is indicative of an image depth classification of each of the plurality of ROIs;
determine a zoomable score for each of the plurality of ROIs based on the geometric feature score and the image depth score; and
determine the at least one zoomable ROI based on the zoomable score.

10. The system as claimed in claim 9, wherein at least one processor, individually and/or collectively, is configured to:
determine a dimension of each of the plurality of ROIs;
determine a grid map for each of the plurality of ROIs based on the dimension, wherein the grid map indicates partitioning each of the plurality of ROIs into a plurality of grid segments;
map the grid map into a plurality of zones, wherein the plurality of zones is indicative of columnar location of each of the plurality of grid segments;
determine a pixel map for each of the plurality of ROIs based on the grid map, wherein the pixel map comprising of a pixel information of the plurality of zones corresponding to each of the plurality of ROIs;
determine an association between the plurality of grid segments based on the grid map and the pixel map,
determine a pivotal coordinate for each of the plurality zones, wherein the pivotal coordinate indicates a starting and an ending point of each of the plurality of zones; and
determine the geometric feature score based on the grid map, the pixel map, the association between the plurality of grid segments, and the pivotal coordinate.

11. The system as claimed in claim 9, wherein at least one processor, individually and/or collectively, is configured to:
sample the plurality of ROIs to determine a geometry of each of the plurality of ROIs in the first image, wherein the sample is indicative of dividing each of the plurality of ROIs into n number of parts;
extract features from each of the sampled plurality of ROIs using a trained machine learning model;
determine a plurality of correlation images and an image depth map for each of the plurality of correlation images based on the extracted features, wherein the plurality of correlation images is structurally equivalent to the plurality of ROIs;
determine a correlation value of each of the plurality of correlation images to select at least one correlation image with the correlation value higher than a specified correlation coefficient;
determine the image depth map for each of the plurality of ROIs based on the image depth map of the selected at least one correlation image; and
determine the image depth score based on the determined image depth map.

12. The system as claimed in claim 7, wherein at least one processor, individually and/or collectively, is configured to:
index the plurality of media objects stored in a database;
prepare a plurality of clusters comprising of the plurality of media objects, based on the plurality of media objects with visually similar features with the first image;
determine an association between the at least one zoomable ROI and the plurality of media objects in each of the plurality of clusters;
determine a similarity score for each of the plurality of media objects in each of the plurality of clusters based on the association; and
retrieve one of the plurality of media objects as the consecutive image from the plurality of clusters based on the similarity score.

13. The system as claimed in claim 7, wherein at least one processor, individually and/or collectively, is configured to:
extract a plurality of zoomable ROI features from the at least one zoomable ROI, wherein the plurality of zoomable ROI features is indicative of an object in the at least one zoomable ROI;
extract a plurality of semantic features from the first image, wherein the plurality of semantic features is indicative of shape, color, size, texture of the object in the at least one zoomable ROI;
concatenate the plurality of semantic features and the plurality of zoomable ROI features to determine a representation of the at least one zoomable ROI;
determine a context feature from the first image based on the first image and an environmental context;
determine a dynamic global-local attention vector from the first image based on the plurality of semantic features and the plurality of ROI features;
generate the consecutive image based on the context feature and the dynamic global-local attention vector.

14. The system as claimed in claim 13, wherein at least one processor, individually and/or collectively, is configured to:
determine generation loss via a semantic arbiter, by comparing a sequential semantics of the generated consecutive image with the first image.

15. The system as claimed in claim 7, wherein at least one processor, individually and/or collectively, is configured to:
create a zoom-in effect on the at least one zoomable ROI;
display the consecutive image such that the media presentation creates the zoom-in effect upon presentation with an image continuity sequence and a semantic relevance.
